(19) United States
(12) Patent Application Publication
(10) Pub. No.: US 2022/0229198 A1
(43) Pub. Date: Jul. 21, 2022

(54) SENSOR ASSEMBLY

(71) Applicants: Rosneft Oil Company, Moscow (RU); BP Exploration Operating Company Limited, Middlesex (GB)

(72) Inventor: Mathias CONTANT, Sandvika (NO)

(73) Assignees: Rosneft Oil Company, Moscow (RU); BP Exploration Operating Company Limited, Middlesex (GB)

(21) Appl. No.: 17/614,289

(22) PCT Filed: May 28, 2019
(86) PCT No.: PCT/RU2019/000370

§ 371 Date: Nov. 24, 2021

(51) Int. Cl. G01V 1/18; G01V 1/16; G01V 13/00

(52) U.S. Cl. CPC G01V 1/18; G01V 13/00; G01V 1/162

(57) ABSTRACT

Example sensor assemblies, seismic sensor incorporating the sensor assemblies, and methods relating thereto are disclosed. In an embodiment, the sensor assembly includes an electrically conductive outer housing, and an electrically insulating holder disposed within the outer housing. The holder comprises a recess. In addition, the sensor assembly includes a sensor element disposed within the recess of the holder. The sensor element is electrically insulated from outer housing by the holder.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Seismic surveying, or reflection seismology, is used to map the Earth's subsurface. During a seismic survey, a controlled seismic source emits low frequency seismic waves that travel through the subsurface of the Earth. At interfaces between dissimilar rock layers, the seismic waves are partially reflected. The reflected waves return to the surface where they are detected by one or more seismic sensors. In particular, the seismic sensors detect and measure vibrations induced by the waves. Ground vibrations detected by the seismic sensors at the earth surface can have a very wide dynamic range, with displacement distances ranging from centimeters to angstroms. Data recorded by the seismic sensors is analyzed to reveal the structure and composition of the subsurface.

### BRIEF SUMMARY

Some embodiments disclosed herein are directed to a sensor assembly for a seismic sensor. In an embodiment, the sensor assembly includes an electrically conductive outer housing, and an electrically insulating holder disposed within the outer housing. The holder comprises a recess. In addition, the sensor assembly includes a sensor element disposed within the recess of the holder. The sensor comprises a sensing element, and is electrically insulated from outer housing by the holder.

Other embodiments disclosed herein are directed to a seismic sensor. In an embodiment, the seismic sensor includes an outer housing having a central axis, an upper end, a lower end, and an inner cavity. In addition, the seismic sensor includes a proof mass moveably disposed in the inner cavity, wherein the outer housing is configured to move axially relative to the proof mass, and a plurality of biasing members disposed within the inner cavity and configured to flex in response to axial movement of the outer housing relative to the proof mass. Further, the seismic sensor includes a sensor assembly disposed in the inner cavity and axially positioned between the proof mass and the lower end of the outer housing. The sensor assembly includes an electrically conductive sensor housing, and an electrically insulating holder disposed within the sensor housing. The holder includes a recess. In addition, the sensor assembly includes a sensor element disposed within the recess of the holder. The sensor comprises a piezoelectric element, and wherein the sensor element is electrically insulated from the sensor housing by the holder.

Still other embodiments disclosed herein are directed to a method of manufacturing a seismic sensor. In an embodiment, the method includes (a) inserting a sensor element within a recess of an electrically insulating holder, (b) enclosing the holder and the sensor element within an electrically conductive sensor housing after (a), and (c) engaging the sensor housing with an end of a carrier after (b). In addition, the method includes (d) suspending a proof mass within the carrier via a plurality of biasing members. Further, the method includes (f) inserting the carrier, the sensor housing, and the proof mass within an outer housing after (c) and (d) such that the sensor element is deflected when the carrier moves relative to the proof mass.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1 is a schematic representation of a seismic surveying system for surveying a subsurface earthen formation according to some embodiments;

FIG. 2 is a perspective view of an embodiment of a seismic sensor which may be used within the system of FIG. 1 according to some embodiments;

FIG. 3 is a longitudinal cross-sectional view of the seismic sensor of FIG. 2;

FIG. 4 is a perspective view of the battery and tabs of the seismic sensor of FIG. 2;

FIG. 5 is an exploded perspective view of an embodiment of a sensor assembly which may be used within the seismic sensor of FIG. 2 according to some embodiments;

FIG. 6 is a perspective view of the sensor assembly of FIG. 5 with the cover plate removed;

FIG. 7 is a perspective view of the sensor assembly of FIG. 5 with the cover plate installed;

FIG. 8 is another perspective view of the sensor assembly of FIG. 5;

FIG. 9 is a perspective view of the sensor assembly of FIG. 5 installed onto the carrier of the seismic sensor of FIG. 2;

FIG. 10 is an enlarged perspective view of the sensor assembly of FIG. 5 installed onto the carrier of the seismic sensor of FIG. 2; and

FIG. 11 is a longitudinal, cross-sectional view of the seismic sensor of FIG. 2 detailing the position and arrangement of the sensor assembly of FIG. 5 therein.

### DETAILED DESCRIPTION

The following discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a port), while the terms “radial” and “radially” generally mean perpendicular to the given axis. For instance, an axial distance refers to a distance measured along or parallel to the axis, and a radial distance means a distance measured perpendicular to the axis. Further, when used herein (including in the claims), the word “about,” “generally,” “substantially,” “approximately,” and the like mean within a range of plus or minus 10%.

As previously described, during a seismic survey, seismic sensors are used to detect reflected seismic waves to reveal the structure and composition of the subsurface. One type seismic sensor relies on capacitance to generate the electrical signal. With one example, these sensors can be constructed as Microelectromechanical systems (MEMS) using micro machined silicon with metal plating applied to facing components on opposite sides of a small plated and spring loaded mass. These MEMS sensors often have the advantage of small size and weight compared to a moving coil geophone. The movement of the MEMS proof mass relative to the outer fixed plates creates variable capacitance that is detected as a signal proportional to the acceleration of the sensor displacement. During operations, electromagnetic interference from other electromagnetic components both within and around the seismic sensor may interfere with the MEMS sensor's ability to produce quality data.

Accordingly, embodiments disclosed herein include seismic sensors, particular MEMS type seismic sensors that include enclosed sensor assemblies for providing electromagnetic shielding for the sensor element(s) housed therein. In at least some embodiments, the enclosed and shielded sensor assemblies are insulated (partially or totally) from any surrounding electromagnetic interference, so that the data quality may be improved (e.g., from that captured by a non-shielded sensor assembly). In addition, at least some embodiments of the sensor assemblies disclosed herein include an electrically insulating holder, which may allow the sensor element(s) within the sensor assembly to be separated (and thus insulated) from an electrically conductive outer housing (or shielding) of the sensor assembly. Further, without being limited to this or any other theory, embodiments of the sensor assemblies disclosed herein may be easier to manufacture and assemble than other sensor assembly designs.

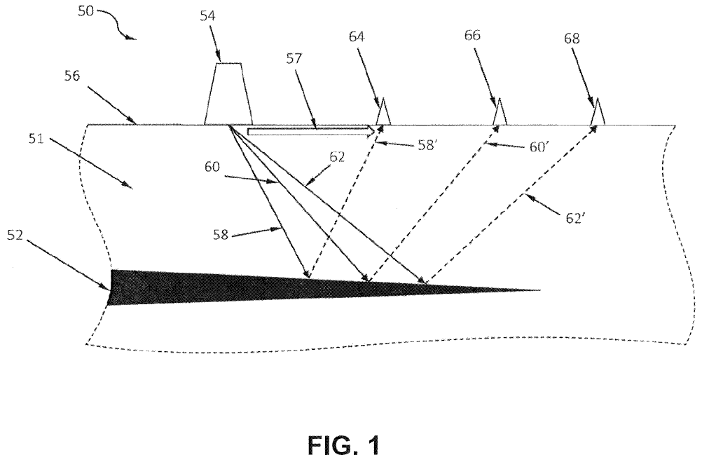

Referring now to FIG. 1, a schematic representation of a seismic surveying system 50 for surveying a subsurface earthen formation 51 is shown. As shown in FIG. 1, the subsurface 51 has a relatively uniform composition with the exception of layer 52, which may be, for example, a different type of rock as compared to the remainder of subsurface 51. As a result, layer 52 may have a different density, elastic velocity, etc. as compared to the remainder of subsurface 51.

Surveying system 50 includes a seismic source 54 disposed on the surface 56 of the earth and a plurality of seismic sensors 64, 66, 68 firmly coupled to the surface 56.

The seismic source 54 generates and outputs controlled seismic waves 58, 60, 62 that are directed downward into the subsurface 51 and propagate through the subsurface 51. In general, seismic source 54 can be any suitable seismic source including, without limitation, explosive seismic sources, vibroseis trucks and accelerated weight drop systems also known as thumper trucks. For example, a thumper truck may strike the surface 56 of the earth with a weight or “hammer” creating a shock which propagates through the subsurface 51 as seismic waves.

Due to the differences in the density and/or elastic velocity of layer 52 as compared to the remainder of subsurface 51, the seismic waves 58, 60, 62 are reflected, at least partially, from the surface of the layer 52. The reflected seismic waves 58′, 60′, 62′ propagate upwards from layer 52 to the surface 56 where they are detected by seismic sensors 64, 66, 68.

The seismic source 54 may also induce surface interface waves 57 that generally travel along the surface 56 with relatively slow velocities, and are detected concurrently with the deeper reflected seismic waves 58′, 60′, 62′. The surface interface waves 57 generally have a greater amplitude than the reflected seismic waves 58′, 60′, 62′ due to cumulative effects of energy loss during propagation of the reflected seismic waves 58′, 60′, 62′ such as geometrical spreading of the wave front, interface transmission loss, weak reflection coefficient and travel path absorption. The cumulative effect of these losses may amount to a 75 dB, and in cases more than 100 dB, in amplitude difference between various waveforms recorded by sensors 64, 66, 68.

The sensors 64, 66, 68 detect the various waves 57, 58′, 60′, 62′, and then store and/or transmit data indicative of the detected waves 57, 58′, 60′, 62′. This data can be analyzed to determine information about the composition of the subsurface 51 such as the location of layer 52.

Although seismic surveying system 50 is shown and described as a surface or land-based system, embodiments described herein can also be used in connection with seismic surveys in transition zones (e.g., marsh or bog lands, areas of shallow water such as between land and sea) and marine seismic survey systems in which the subsurface of the earthen formation (e.g., subsurface 51) is covered by a layer of water. In marine-based systems, the seismic sensors (e.g., seismic sensors 64, 66, 68) may be positioned in or on the seabed, or alternatively on or within the water. In addition, in such marine-based systems, alternative types of seismic sources (e.g., seismic sources 54) may be used including, without limitation, air guns and plasma sound sources.

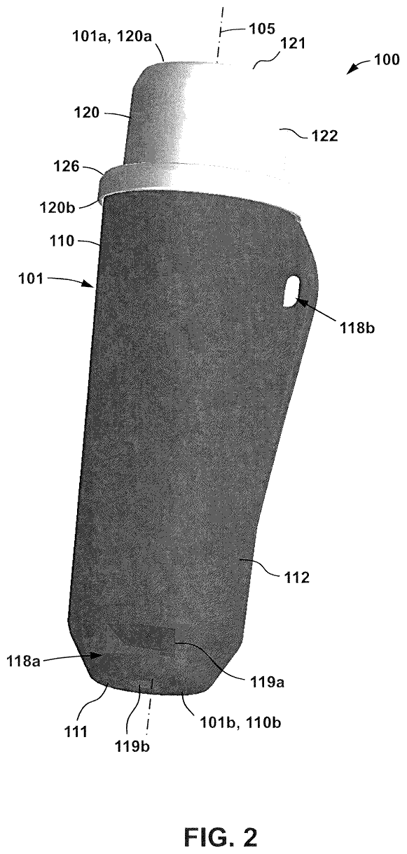

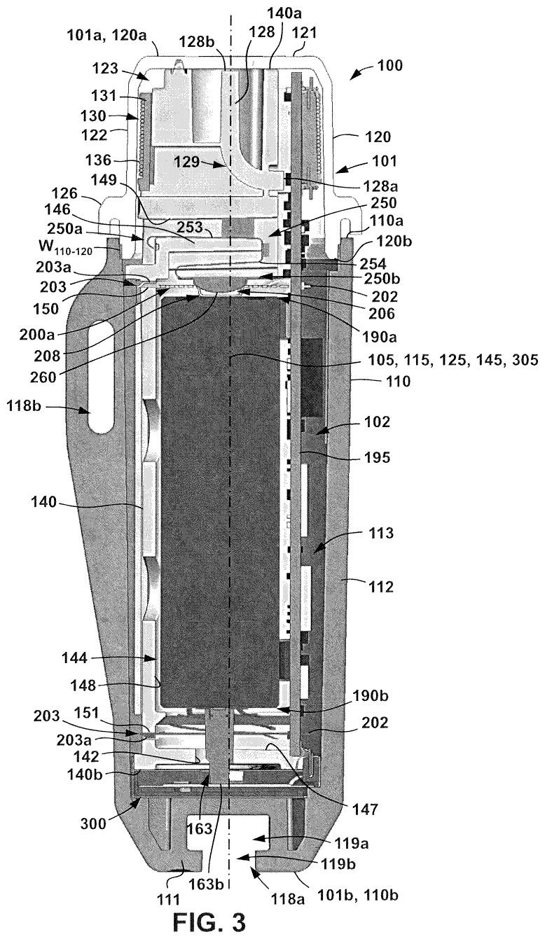

Referring now to FIGS. 2 and 3, an embodiment of a seismic sensor 100 is shown. In general, seismic sensor 100 can be used in any seismic survey system. For example, sensor 100 can be used for any one or more of sensors 64, 66, 68 of seismic surveying system 50 shown in FIG. 1 and described above. Although sensor 100 can be used in land or marine seismic survey systems, it is particularly suited to land-based seismic surveys. Generally speaking, seismic sensor 100 may include many similar components to those discussed in U.S. Pat. No. 10,139,506, filed Mar. 12, 2015, which is hereby incorporated by reference in its entirety for all purposes.

In this embodiment seismic sensor 100 includes an outer housing 101, an inductive spool assembly 130 disposed within housing 101, a carrier 140 disposed in housing 101, and a sensor assembly 300 disposed within housing 101 and coupled to carrier 140. Housing 101 has a central or longitudinal axis 105, a first or upper end 101a, a second or lower end 101b, and an inner chamber or cavity 102. Ends 101a, 101b are closed and inner cavity 102 is sealed and isolated from the environment surrounding sensor 100, thereby protecting the sensitive components disposed within housing 101 from the environment (e.g., water, dirt, etc.). In addition, housing 101 includes a generally cup-shaped body 110 and an inverted cup-shaped cap 120 fixably attached to body 110.

Body 110 has a central or longitudinal axis 115 that is coaxially aligned with axis 105, a first or upper end 110a, and a second or lower end 110b defining lower end 101b of housing 101. In addition, body 110 includes a base 111 at lower end 110b and a tubular sleeve 112 extending axially upward from base 111 to upper end 110a. Base 111 closes sleeve 112 at lower end 110b; however, sleeve 112 and body 110 are open at upper end 110a. As a result, body 110 includes a receptacle 113 extending axially from upper end 110a to base 111. Receptacle 113 forms part of inner cavity 102 of housing 101.

In this embodiment, body 110 of outer housing 101 includes a pair of connectors 118a, 118b. Connector 118a is provided on base 111 and connector 118b is provided along sleeve 112. Connector 118a includes rectangular throughbore 119a extending radially therethrough and a hole 119b extending axially from lower end 110b to throughbore 119a. Hole 119b is internally threaded and threadably receives the externally threaded end of a spike (not shown) used to secure sensor 100 to the ground during seismic survey operations. Throughbore 119a enables a rope or the like (not shown) to be attached to sensor 100 for storage or deployment. In particular, the rope may be folded double and inserted throughbore 119a. Thus, bore 119a has a width of at least twice the diameter of the rope. The loop formed by the portion of folded rope extending through bore 119a is then placed around the sensor 100. In this manner, a plurality of sensors 100 can be coupled to a single rope without side ropes, hooks or other mechanisms that can complicate the handling of multiple sensors 100.

The connector 118b is disposed along the outside of sleeve 112 proximal upper end 101a. In general, connector 118b provides an alternative connection point for handling of sensor 100 during deployment and retrieval. In this embodiment, connector 118b is an eye connector or throughbore to which a rope, lanyard, hook, carabiner or the like can be releasably attached. Connector 118b can also be used in a manner similar to throughbore 119a, thereby allowing a rope to be folded double and inserted through the hole of connector 118b. Thus, the bore of connector 118a has a width of at least twice the diameter of the rope. The loop formed by the portion of folded rope extending through the bore of connector 118b is then placed around the sensor 100. In this manner, a plurality of sensors 100 can be coupled to a single rope without side ropes, hooks or other mechanisms that can complicate the handling of multiple sensors. In this embodiment, the entire body 110 (including base 111 and sleeve 112) is made via injection molding.

Referring still to FIGS. 2 and 3, cap 120 has a central or longitudinal axis 125 that is coaxially aligned with axis 105, a first or upper end 120a defining upper end 101a of housing 101, and a second or lower end 120b. In this embodiment, cap 120 has the general shape of an inverted cup. In particular, cap 120 includes a planar cylindrical top 121 at upper end 120a and a tubular sleeve 122 extending axially downward from top 121 to lower end 120b. Top 121 closes sleeve 122 at upper end 120a; however, sleeve 122 and cap 120 are open at lower end 120b. As a result, cap 120 includes an inner chamber or cavity 123 extending axially from lower end 120b to top 121. An annular flange 126 extends radially outward from sleeve 122 proximal lower end 120b.

Cap 120 is fixably attached to body 110 such that cap 120 is coaxially aligned with body 110 and such that lower end 120b of cap 120 seated within upper end 110a of body 110 and upper end 110a of body 110 coupled to flange 126. Body 110 and cap 120 are sized such that an interference fit is provided between lower end 120b of cap 120 and upper end 110a of body 110. In this embodiment, body 110 and cap 120 are made of the same material (polycarbonate), and thus, are can be ultrasonically welded together to fixably secure cap 120 to body 110. More specifically, as shown in FIG. 3 an annular ultrasonic weld W₁₁₀₋₁₂₀ is formed between the opposed radially outer surface and radially inner surface of sleeves 122, 112, respectively, at ends 120b, 110a. Weld W₁₁₀₋₁₂₀ defines an annular seal between cap 120 and body 110 that prevents (or at least restricts) fluid communication between cavities 113, 123 and the environment surrounding sensor 100.

Referring still to FIGS. 2 and 3, a power source or supply 190 and electronic circuitry 195 are removably mounted to carrier 140 within housing 101, particularly within cavity 113 of body 110. In this embodiment, power supply 190 is a battery and electronic circuitry 195 is in the form of a circuit board (e.g., PCB). Thus, power supply 190 may also be referred to as battery 190 and electronic circuitry 195 may also be referred to as circuit board 195. Electronic circuitry 195 is fixably mounted to carrier 140 within housing 101. In addition, a battery 190 is movably disposed within housing 101 such that battery 190 is configured to move axially relative to housing 101 (with respect to axis 105 described below), carrier 140, and circuitry 195 during operations. Generally speaking, battery 190 includes a first or upper end 190a and a second or lower end 190b, opposite upper end 190a. When battery 190 is inserted within cavity 102 of housing 101, upper end 190a of battery 190 is more proximate upper end 101a than lower end 101b and lower end 190b of battery 190 is more proximate lower end 101b than upper end 101a.

Inductive spool assembly 130 is used to inductively charge the battery 190 from the outside of sensor 100 (e.g., wirelessly). In this embodiment, spool assembly 130 is mounted within cavity 123 of cap 120 and includes a cylindrical sleeve-shaped body 131 and a coil 136 wound around body 131. Coil 136 is electrically coupled to circuit board 195 with wires or other suitable conductive paths (not shown) that enable the transfer of current to circuit board 195, which in turn charges battery 190 during charging operations.

Referring still to FIGS. 2 and 3, in this embodiment, carrier 140 supports circuit board 195 and a light guide 128 within cavity 102 of outer housing 110. In this embodiment, carrier 140, circuit board 195, and light guide 128 are fixably coupled to outer housing 101 and do not move relative to outer housing 110, however, battery 190 is movably coupled to carrier 140, and thus, battery 190 (which may be referred to herein as a “proof mass” for seismic sensor 100) can move axially relative to carrier 140, circuit board 195, light guide 128, and outer housing 101.

Carrier 140 has a central or longitudinal axis 145 coaxially aligned with axis 105, a first or upper end 140a extending through inductive spool assembly 130, and a second or lower end 140b axially adjacent base 111. Carrier 140 has an axial length that is substantially the same as the axial length of cavity 102. Thus, upper end 140a engages top 121 of cap 120 and lower end 140b is coupled to sensor assembly 300 which in turn is supported by base 111 of body 110. More specifically, carrier 140 is axially compressed between cap 120 and body 110. As a result, movement of carrier 140 relative to outer housing 101 is generally restricted (or prevented entirely) during operations, so that carrier 140 is fixably secured or mounted within housing 101.

Referring still to FIGS. 2 and 3, carrier 140 includes an axially extending internal recess or pocket 144. Pocket 144 is defined by an upper end surface 149, a lower end surface 147, and a cylindrical surface 148 extending axially between end surfaces 149, 147. Battery 190 is disposed within pocket 144 but does not contact carrier 140. In particular, the dimensions of pocket 144 are greater than the dimensions of battery 190 (e.g., the radius of surface 148 is greater than the outer radius of battery 190, and the axial distance between end surfaces 149, 147 is greater than the length of battery 190 between ends 190a, 190b). In this embodiment, battery 190 is oriented parallel to but is slightly radially offset from aligned axes 105, 145. In particular, the central axis (not shown) of battery 190 is radially offset from axes 105, 145 by about 1.0 to 1.5 mm.

Referring specifically now to FIG. 3, carrier 140 also includes a projection 146 that extends generally radially within pocket 144, and that is axially positioned between upper end 190a of battery 190 and upper surface 149. In addition, carrier 140 includes a first or upper annular recess 150, and second or lower annular recess 151. Upper annular recess 150 extends radially outward from cylindrical surface 148 of pocket 144 within carrier 140 proximate upper end 110a of body 110 but axially below projection 146, and lower annular recess 151 extends radially outward from cylindrical surface 148 of pocket 144 proximate base 111. Further, carrier 140 includes a throughbore 142 extending through lower surface 147 of pocket 144 in a direction that is generally parallel to aligned axes 105, 145.

Referring still to FIG. 3, elongate curved L-shaped light guide 128 is fixably secured to carrier 140 generally axially above pocket 144 within cavity 123 of cap 120. In this embodiment, light guide 128 is integral with and monolithically formed with carrier 140. Light guide 128 is generally “L” shaped, and thus includes a first end 128a, a second end 128b and a 90° curve or corner 129 between ends 128a, 128b. As will be described in more detail below, light guide 128 wirelessly communicates data to/from circuit board 195 through top 121. To facilitate the transmission of light, light guide 128 and top 121 are made of a clear material. In this embodiment, the entire cap 120 (including top 121 and sleeve 122) and guide 128 are made of a clear polycarbonate.

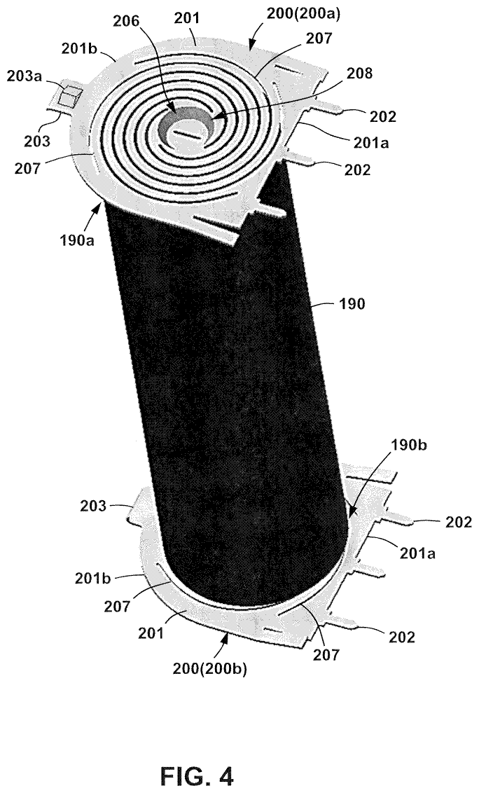

Referring now to FIGS. 3 and 4, battery 190 has a cylindrical shape and is coupled to circuit board 195 with a pair of tabs 200. In particular, tabs 200 are disposed at the ends 190a, 190b of battery 190 and are spring loaded to axially compress battery 190 therebetween (e.g., with respect to aligned axes 105, 145). In this embodiment, tabs 200 are made of metal (e.g., steel, such as spring steel), and provide both a physical and electrical connection between battery 190 and circuit board 195. Thus, tabs 200 enable battery 190 to provide power to circuit board 195 and the various functions performed by the components of board 195 during seismic survey operations, and enable board 195 to provide power to battery 190 during inductive charging operations.

In this embodiment, each tab 200 is a resilient, semi-rigid element through which battery 190 is supported within pocket 144 of carrier 140. As best shown in FIG. 4, each tab 200 comprises a resilient disc 201, a plurality of prongs 202 extending radially from disc 201, and a connector 203 extending radially from disc 201 (e.g., with respect to axis 105 previously described). Connector 203 includes an axially extending raised bump or projection 203a (e.g., axially with respect to axis 105 previously described). As best shown in FIG. 4, disc 201 has a semi-cylindrical shape including a straight edge 201a and a semi-circular edge 201b extending from straight edge 201a. Prongs 202 extend from straight edge 201a and connector 203 extends from semi-circular edge 201b opposite prongs 202.

For purposes of clarity and further explanation, the tab 200 coupled to upper end 190a of battery 190 may be referred to as the upper tab 200a and the tab 200 coupled to lower end 190b of battery 190 may be referred to as the lower tab 200b. Generic references herein to “tabs 200” refer to both the upper tab 200a and lower tab 200b. The semi-circular edge 201b of upper tab 200a is seated in upper recess 150 of carrier 140, and the semi-circular edge 201b of lower tab 200b is seated in lower recess 151 of carrier 140. As best shown in FIG. 3, projection 203a of connector 203 in upper tab 200a is seated within upper recess 150, and projection 203a of connector 203 of lower tab 200b is seated in lower recess 151. The positioning of edges 201b and connectors 203 in recesses 250, 251 maintains the outer periphery of tabs 200 generally static or fixed relative to carrier 140 and outer housing 101. In this embodiment, prongs 202 of tabs 200 extend through circuit board 195 and are soldered thereto.

Referring still to FIGS. 3 and 4, upper tab 200a includes a central projection 208 and a plurality of uniformly circumferentially-spaced through cuts or slots 207 radially positioned between projection 208 and edges 201a, 201b. Upper tab 200a is oriented such that central projection 208 faces and extends toward upper end 190a of battery 190 in an axial direction (e.g., axially with respect to aligned axes 105, 145). In addition, projection 208 forms or defines a receptacle or recess 206 on an opposing side of upper tab 200a (e.g., a side of upper tab 200a that faces axially away from upper end 190a of battery 190). Projection 208 is fixably coupled to the upper end 190a of battery 190. In particular, in this embodiment terminal wall 206b of projection 208 is spot welded to the upper end 190a of battery 190.

Lower tab 200b does not include a projection 208 and recess 206 as described above for upper tab 200a and instead includes a cylindrical post 163 extending axially therefrom (see FIG. 3). As best shown in FIG. 3, cylindrical post 163 extends axially away from lower end 190b of battery 190 and through throughbore 142 when lower tab 200b is installed within cavity 102 as described above. As will be described in more detail below, post 163 can freely move axially within throughbore 142 as outer housing 101 and carrier 140 axially reciprocate relative to battery 190 during operations.

Referring still to FIGS. 3 and 4, each slot 207 within tabs 200 extends axially through the corresponding tab 200. In addition, each slot 207 spirals radially outward moving from a radially inner end proximal central projection to edges 201a, 201b. In this embodiment, four slots 207 are provided, each pair of circumferentially adjacent inner ends of slots 207 are angularly spaced 90° apart about axis 145, each pair of circumferentially adjacent outer ends of slots 207 are angularly spaced 90° apart about axis 145, and each slot 207 extends along a spiral angle measured about axis 145 between its ends of about 360°. The radially inner ends of slots 207 on upper tab 200a are radially adjacent projection 208, and the radially inner ends of slots 207 on lower tab 200b are radially adjacent post 163.

As previously described, tabs 200 provide electrical couplings between battery 190 and circuit board 195. In addition, tabs 200 function like flexures or biasing members for suspending battery 190 within pocket 144. Accordingly, tabs 200 may also be referred to as flexures or biasing members. In particular, tabs 200 are resilient flexible elements that flex and elastically deform in response to relative axial movement of outer housing 101 and carrier 140 relative to battery 190. In addition, tabs 200 radially bias battery 190 to a central or concentric position within pocket 144 radially spaced from carrier 140. In particular, the presence of spiral slots 207 enhances the flexibility of tab 200 in the region along which slots 207 are disposed, thereby allowing that region to flex in the axial direction (up and down) with relative ease. Spiral slots 207 also enhance the flexibility of each tab 200 in the radial direction. However, spiral slots 207 may generally resist some flexing of tabs 200 in the radial direction. Due to the relatively high degree of flexibility of tabs 200 in the axial direction, when an axial load is applied to tabs 200 by carrier 140 or battery 190, slots 207 generally allow free relative axial movement between central projection 208 and edges 201a, 201b on upper tab 200a and free relative axial movement between post 163 and edges 201a, 201b on lower tab 200b. However, due to the more limited flexibility in the radial direction, when a radial load is applied to tabs 200 by carrier 140 or battery 190, slots 207 may generally resist relative some (but not necessarily all) radial movement between the central projection 208 and edges 291a, 291b of upper tab 200a and between post 163 and edges 201a, 201b of lower tab 200b. Thus, tabs 200 bias battery 190 and carrier 140 back into substantial coaxial alignment with axes 105, 145 (but with the radial offset of battery 190 as previously described above).

Referring still to FIGS. 3 and 4, a biasing member 250 is installed within pocket 144 of carrier 140 and is engaged with upper tab 200a. Generally speaking, biasing member 250 is a flat spring that includes a first end 250a, a second end 250b, and a body 252 extending between ends 250a, 250b. Body 252 includes a first or fixed portion 253 and a second or free portion 254. Fixed portion 253 extends from first end 250a, and free portion 254 extends from fixed portion 253 to second end 250b. A projection 260 is mounted to free portion 254 of biasing member 250, proximate second end 250b.

As shown in FIG. 3, fixed portion 253 is disposed about projection 146 in receptacle 144 such that free portion 254 and projection 260 extend generally axially from projection 146 toward upper tab 200a and battery 190. In particular, projection 260 is biased into recess 206 by body 252 to further axially compress battery 190 between tabs 200 and biasing member 250 and to promote alignment between projection 260, upper tab 200a, and battery 190 in a direction that is parallel to and radially offset from aligned axes 105, 145. Thus, the engagement between projection 260 and recess 206 may further bias battery 190 toward a central position within pocket 144 in the radial direction with respect to aligned axes 105, 145.

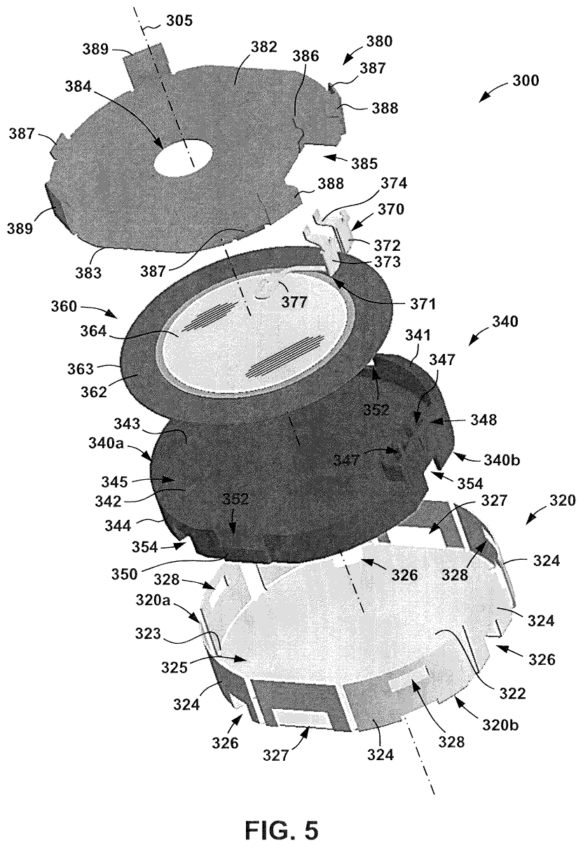

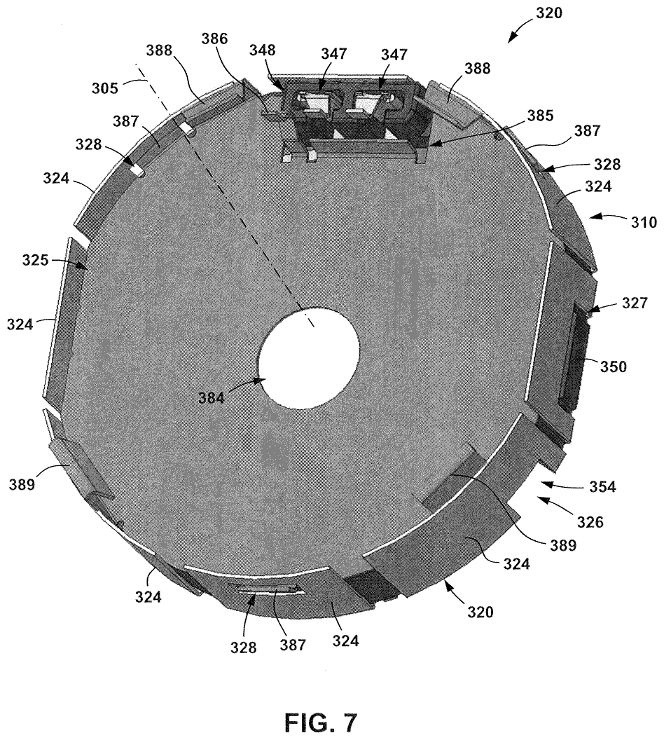

Referring now to FIGS. 5-8, sensor assembly 300 has a central or longitudinal axis 305 that is coaxially aligned with axis 105 (see e.g., FIG. 3). In addition, sensor assembly 300 generally includes a cup 320, a holder 340, a sensor element 360, and a cover plate 380 all arranged or stacked along axis 305. As will be described in more detail below, cup 320, holder 340, and cover plate 380 function to insulate sensor element 360 from electromagnetic interference that may be present within cavity 102 of sensor 100. Each of the specific components of sensor assembly 300 will now be described in more detail below.

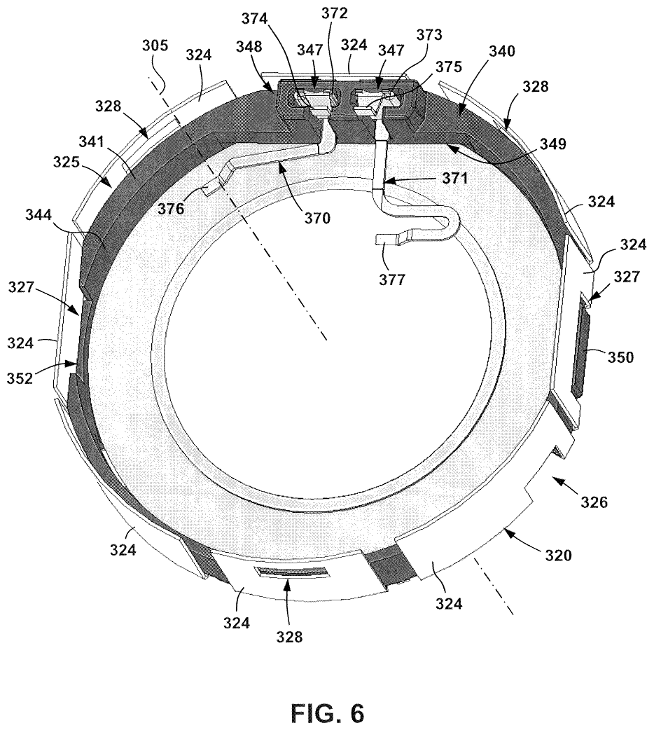

Referring still to FIGS. 5 and 6, cup 320 includes a first end 320a, and a second end 320b opposite first end 320a. In addition, cup 320 includes a planar base plate 322 disposed at second end 320b that is oriented radially relative to axis 305, and a plurality of wall segments 324 that extend axially from an outer periphery 323 of base plate 322 to first end 320a. Together, base plate 322 and wall segments 324 form a recess 325 that extends axially from first end 320a to plate 322. As will be described in more detail below, recess 325 receives the other components of sensor assembly 300 (e.g., holder 340, sensor element 360, cover plate 380, etc.) during operations.

In addition, a plurality of holes or apertures extend into recess 325 through the base plate 322 and wall segments 324. In particular, cup 320 includes a plurality of first apertures 326, a plurality of second apertures 327, and a plurality of third apertures 328.

The plurality of first apertures 326 each extend through corresponding ones of the wall segments 322 and through a portion of base plate 322 at the outer periphery 323. In this embodiment, the first apertures 326 are uniformly angularly spaced about axis 305. More specifically, there are a total of three first apertures 326 spaced approximately 120° apart from one another about axis 305. The plurality of second apertures 327 each extend through corresponding ones of the wall segments 324 at the intersection of the corresponding wall segments 324 and the periphery 323 of base plate 322. In this embodiment, second apertures 328 are uniformly angularly spaced about axis 305. More specifically, there are a total of two second apertures 327 disposed radially opposite one another (i.e., disposed approximately 180° from one another) about axis 305. The plurality of third apertures 328 each extend through corresponding ones of the wall segments 324 at points that are axially spaced from periphery 323. In this embodiment, third apertures 328 are uniformly angularly spaced about axis 305. More specifically, there are a total of three third apertures 328 spaced approximately 120° apart from one another about axis 305.

Cup 320 comprises a conductive material (e.g., a metal). In some specific embodiments, cup 320 may comprise, for example, steel, aluminum, copper, etc. As will be described in more detail below, cup 320 is configured to conduct electrical current and/or interference away from sensor element 360 during operations so as to improve operations thereof. In addition, in this embodiment, wall segments 324 are monolithically formed with base plate 322, and thus each comprises the same material. However, it should be appreciated that in other embodiments, wall segments 324 and base plate 322 may be formed as separate bodies or members that are connected or coupled together.

Referring still to FIGS. 5-8, holder 340 includes a first end 340a, and a second end 340b opposite first end 340a. In addition, holder 340 includes a planar base 342 at second end 340b that is oriented radially relative to axis 305, and an annular wall 344 extending axially from base 342 to first end 340a. In particular, wall 344 extends axially from an outer periphery 343 of base 322 and includes an upper planar annular shoulder or surface 341 at first end 340a. Together, base 342 and wall 344 form a recess 345 that extends axially from first end 340a to base 342. As will be described in more detail below, recess 345 receives sensor element 360 therein during operations.

A pair of projections 350 extend radially outward from wall 344, and a pair of axially extending recesses 352 extend axially inward to wall 344 from annular surface 341 to projections 350. In this embodiment, each of the projections 350 and corresponding recesses 352 are radially opposite (i.e., disposed approximately 180° from) one another about axis 305.

In addition, holder 340 includes a receptacle 348 disposed along wall 344. In particular, receptacle 348 extends axially upward from annular wall 341 and includes a pair of slots 347. As will be described in more detail below, slots 347 are configured to receive corresponding electrical connectors therein for electrically connecting sensor element 360 to circuit board 195 (see FIG. 3) during operations. Further, as is best shown in FIG. 6, holder 340 also includes a retention recess 349 that extends radially outward and into wall 344 at receptacle 348.

As is best shown in FIG. 5, a plurality of apertures 354 each extend into recess 345 through wall 344 and through a portion of base plate 342 at the outer periphery 343. In this embodiment, the apertures 354 are uniformly angularly spaced about axis 305. More specifically, there are a total of three apertures 354 spaced approximately 120° apart from one another about axis 305.

Holder 340 comprises an electrically insulating material (e.g., a polymer, a composite (e.g., fiberglass), etc.). As will be described in more detail below, holder 340 is configured to electrically insulate sensor element 360 from other conductive portions of sensor assembly 300 during operations (e.g., cup 320, cover plate 380, etc.).

Referring still to FIGS. 5-8, sensor element 360 comprises a disc or substrate 362 that includes an outer periphery 363. In addition, sensor element 360 includes a piezoelectric element 364 comprising one or more layers of a rigid piezoelectric ceramic material disposed on a substrate which forms the outer periphery 363. In some embodiments, the piezoelectric ceramic material comprises lead zirconate titanate (PZT) which is regarded as low cost and relatively strong. Disc 362 may be electrically conductive and may comprise beryllium copper or brass in some embodiments. The one or more layers of piezoelectric ceramic material of element 364 may be bonded to (and potentially disposed between) one or more layers of the substrate to provide a substantially flat member. During operations, the sensor element 360 may have a sufficient elastic compliance so as to support the proof mass (e.g., battery 190) of sensor 100 without fracturing. In addition, the sensor element 360 (including the one or more layers of piezoelectric ceramic material and substrate) may have a bending stiffness which is greater than the piezoelectric ceramic material alone. In some embodiments, the sensitivity and resonance peak frequency of the sensor element 360 may be set based on various factors (e.g., the diameter and thickness of sensor element 360—particularly of the piezoelectric ceramic material, the ratio of Titanium to zirconium in the piezoelectric ceramic material, etc.).

Cover plate 380 includes a planar base plate 382 that is oriented radially relative to axis 305 and that includes an outer periphery 383. A recess or notch 385 extends radially inward from periphery 383. In addition, an aperture 384 extends through plate 382 at a position that is spaced from periphery 383 but is radially shifted slightly from axis 305.

A plurality of tabs or projections extend generally axially from periphery 383 of base plate 382. In particular, base plate 382 includes a plurality of first tabs 387, a plurality of second tabs 388, and a plurality of third tabs 389. The plurality of first tabs 387 each extending from periphery 383 of base plate 382. In this embodiment, the first tabs 387 are uniformly angularly spaced about axis 305. More specifically, there are a total of three first tabs 387 spaced approximately 120° apart from one another about axis 305. The plurality of second tabs 387 each also extend from the periphery 383 of base plate 382. In this embodiment, there are two second tabs 388 disposed on opposing angular sides of recess 385. In particular, each second tab 388 is disposed angularly between recess 385 and corresponding ones of the first tabs 387. The plurality of third tabs 389 each also extend from the periphery 383 of base plate 382. In this embodiment, there are two third tabs 389 disposed along periphery 383 generally on a side of cover plate 380 that is radially opposite recess 385. In addition, a first connector tab 386 extends axially upward from a wall or border of notch 385.

Cover plate 380 comprises a conductive material, such as, for example, a metal. In some specific embodiments, cover plate 380 may comprise, for example, steel, aluminum, copper, etc. In addition, in some embodiments, cover plate 380 may comprise the same conductive material as cup 320; however, this may not be the case in other embodiments. As will be described in more detail below, cover plate 380 is configured to conduct electrical current and/or interference away from sensor element 360 and into cup 320 during operations so as to improve operations thereof.

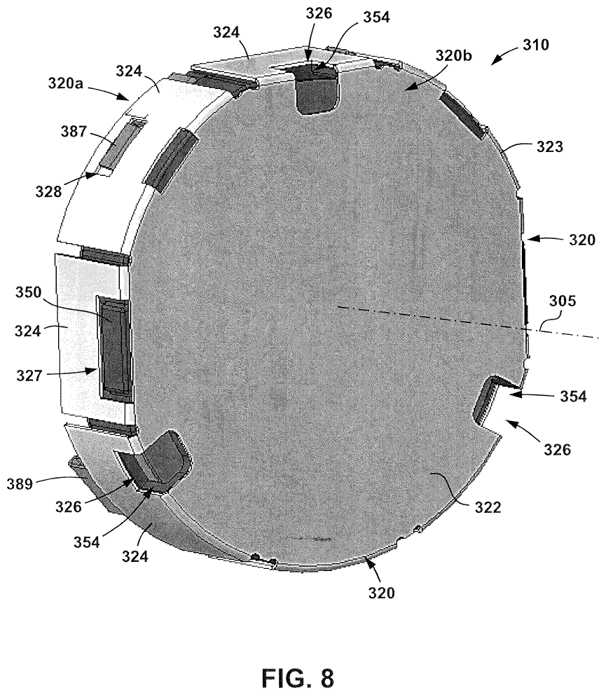

Referring now to FIGS. 5 and 6, to construct sensor assembly 300, holder 340 is inserted axially within recess 325 of cup 320 until second end 340b engages with base plate 322. In addition, annular wall 344 slidingly engages with wall segments 324 of cup 320 as holder 340 is inserted axially within recess 325. Further, when seated within recess 325, holder 340 is angularly aligned with cup 320 about axis 305 such that the plurality of apertures 354 on holder 340 are angularly aligned with the plurality of first apertures 326 in cup 320. Referring briefly again to FIG. 8, the aligned apertures 354, 326 provide open path ways into recess 345 of holder 340 from second end 320b of cup 320.

Referring again to FIGS. 5 and 6, when holder 340 is inserted axially within recess 325 of cup 320, projections are aligned with and are inserted within the second apertures 327 in cup 320. In this embodiment, the insertion of holder 340 within recess 325 of cup 320 causes sliding engagement between projections 350 and the wall segments 324 carrying second apertures 327, such that these wall segments 324 are deformed radially outward from axis 305. Once projections 350 axially align with apertures 327, the corresponding wall segments 324 rotate radially inward so as to fully engage projections 350 through apertures 327. As a result, once holder 340 is installed within recess 325 of cup 320 in this manner, the engagement between projections 350 and second apertures 327 prevents accidental withdrawal or rotation of holder 340 from or within, respectively, recess 320.

Either before or after holder 340 is inserted within recess 325 of cup 320, sensor element 360 is installed within recess 325. In particular, sensor element 360 is inserted within recess 325 such that periphery 363 is inserted radially into retention recess 349 of holder 340. Thereafter, a pair of electrical leads or connectors 370, 371 are installed within slots 347 of receptacle 348 to provide electrical connection with sensor element 360 and other components within sensor 100 (e.g., circuit board 195).

In particular, the pair of electrical connectors 370, 371 comprises a first connector 370 and a second connector 371. First connector 370 includes a central body 372, a first conductive lead 374 extending from body 372, and a second conductive lead 376 extending from body 372. Similarly, second connector 371 includes a central body 373, a first conductive lead 375 extending from body 373, and a second conductive lead 377 extending from body 373. In this embodiment, the body 372 and leads 374, 376 of first connector 370 are all made of electrically conductive materials (e.g., a metal), and may, in some embodiments, be formed of the same material (e.g., such that body 372 and leads 374, 376 of first connector 370 are monolithically formed). Similarly, in this embodiment, body 373 and leads 375, 377 of second connector 371 are also all made of electrically conductive materials, and may, in some embodiments, be formed of the same material (e.g., such that body 373 and leads 375, 377 of second connector 371 are monolithically formed). As best shown in FIG. 6, body 372 of first connector 370 is installed within one of the slots 374 of receptacle 348 such that second lead 376 engages with metallic disc 362 of sensor element 360 and first lead 374 extends axially (generally) from first end 340a of holder 340 via the corresponding slot 347. In addition, body 373 of second connector 371 is installed within the other of the slots 374 of receptacle 348 such that second lead 377 engages with piezoelectric element 364 of sensor element 360 and first lead 375 extends axially (generally) from first end 340a of holder 340 via the corresponding slot 347. In some embodiments, second leads 376, 377 (or some portion thereof) may be soldered or otherwise conductively secured to disc 362 and element 364, respectively, of sensor element 360; however, such connection is not required. In addition, in this embodiment, each of the leads 376, 377 of connectors 370, 371, respectively are biased into engagement with sensor element 360 (specifically disc 362 and piezoelectric element 364, respectively). In one or more embodiments, first connector 370 is a separate piece from second connector 371. First connector 370 is connected to disc 362. Second connector 371 is connected to element 364 via second lead 377. By configuring first connector 370 to the outer edge of disc 362, the quality-of-response of piezoelectric element 364 of sensor element 360 can be improved. Second connector 371 (as shown in FIG. 6) can include a bend in order to increase the length of second connector 371. This increase in length can increase the flexibility of second connector 371, in order to generate less counter-force when the disc 362 is deformed, and thus increasing the flexibility of second connector 371 can exhibit improved sensor performance.

Referring now to FIGS. 5-7, once sensor element 360 and connectors 370, 371 are installed within holder 340 as described above, cover plate 380 is also inserted within recess 325 of cup 320 until base plate 382 engages with annular surface 341 on holder 340. In particular, cover plate 380 is angularly aligned with holder 340 and cup 320 so that notch 385 is angularly aligned with receptacle 348 and first tabs 387 are angularly aligned with the wall segments 324 of cup 320 that carry third apertures 328. Still more specifically, as cover plate 380 is axially advanced within recess 325, first tabs 387 slidingly engage with the radially inner surface of the wall segments 324 carrying third apertures 328. The engagement between first tabs 387 and these corresponding wall segments 324 causes the wall segments 324 to deflect radially outward or away from axis 305 until first tabs 387 are aligned with third apertures 387. Thereafter, tabs 387 are received through apertures 328 so that the corresponding wall segments 324 rotate radially inward toward axis 305 thereby securing cover plate 380 to cup 320. In addition, when cover plate 380 is installed within recess 325 of cup 320 as described above, second tabs 388 and third tabs 389 and periphery 383 are engaged with corresponding ones of the wall segments 324. Thus, once installed within assembly 300, cover plate 380 is electrically coupled to cup 320 via contact between tabs 387, 388, 389 and periphery 383 of cover plate 380 and wall segments 324 of cup 320.

Accordingly, when sensor assembly 300 is fully constructed as described above, cover plate 380 and cup 320 form an outer housing 310 (or sensor housing 310) that receives sensor element 360 and holder 340 therein. In addition, sensor element 360 is installed within housing 310 such that no contact is formed between sensor element 360 (or connectors 370, 371) and either cover plate 380 and cup 320. Rather, sensor element 360 and connectors 370, 371 are in contact with holder 340 within housing 310. Because cover plate 380 and cup 320 are constructed from electrically conductive materials, the housing 310 forms an electrically conductive shell around sensor element 360 that protects or shields sensor element 360 from electromagnetic interference generated outside of housing 310. In other words, housing 310 forms a so-called “Faraday cage” about sensor element 360.

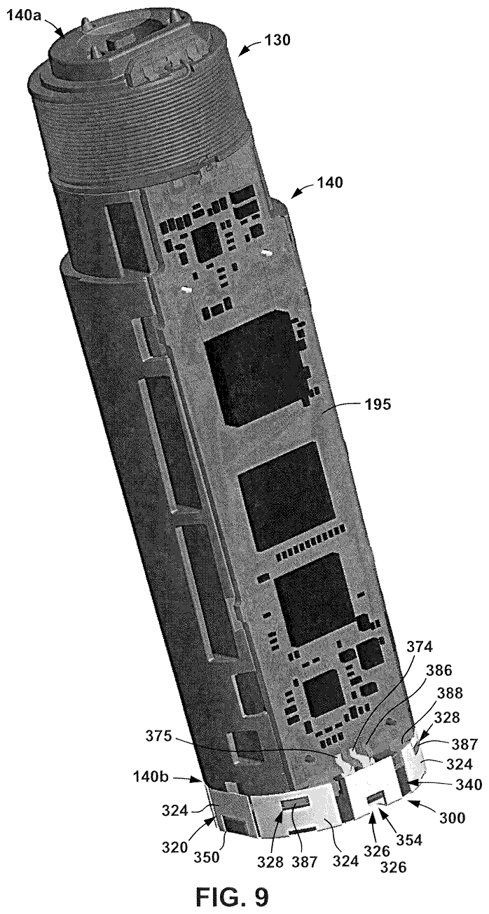

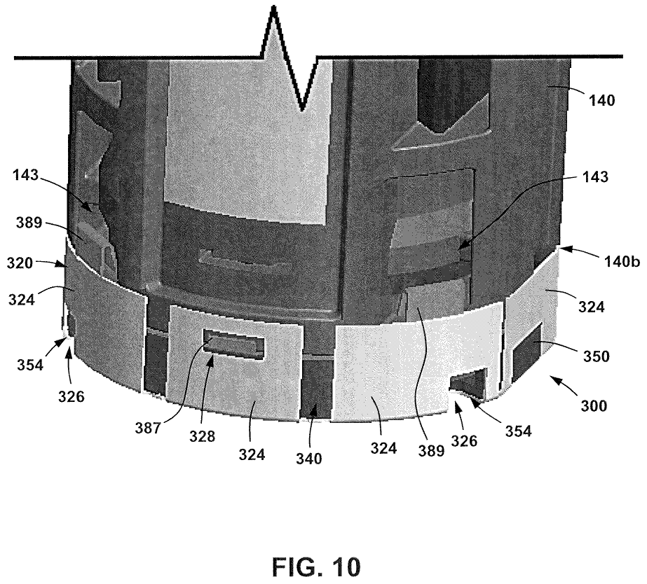

Referring now to FIGS. 3 and 9, once constructed, sensor assembly 300 is secured to the lower end 140b of carrier 140 so that together, inductive spool assembly 130, carrier 140, circuit board 195, sensor assembly 300, battery 190, and biasing members 200, 180 may be installed within outer housing 101. In particular, as shown in FIG. 10, the third tabs 389 on cover plate 380 engage with corresponding recesses 143 formed on an outer surface of carrier 140 so that sensor assembly 300 is secured to lower end 140b of carrier 140 as described above. In particular lower end 140b of carrier 140 is engaged with base plate 382 of cover plate 380.

Referring again to FIG. 9, when sensor assembly 300 is mounted to lower end 140b of carrier 140 as described above, leads 374, 375 of connectors 370, 371, respectively (see e.g., FIG. 6) are engaged with corresponding portions or components on circuit board 195 (e.g., such as solder pads on circuit board 195). In this embodiment, the leads 374, 375 may also be soldered to circuit board 195; however, in other embodiments, leads 374, 375 simply contact circuit board 195 during operations. Thus, once leads 374, 375 are engaged (and soldered in this embodiment) to circuit board 195, sensor element 360 is electrically coupled to circuit board 195. In addition, when sensor assembly 300 is engaged with lower end 140b of carrier 140, connector tab 386 of cover plate 380 is also engaged with (and possibly soldered to) a corresponding portion or component on circuit board 195 (e.g., such as a soldering pad as described above for leads 374, 375). In this embodiment, the connector tab 386 provides a grounding contact for housing 310 that is electrically coupled to the ground of circuit board 195. Moreover, in some embodiments, all (or some) of the leads 374, 375, 386 are biased into engagement with circuit board 195 (or solder pads disposed on circuit board 195).

Thus, the sensor assembly 300 may be assembled and electrically coupled to other components within seismic sensor 100 (e.g., circuit board 195) with relative ease (e.g., a technician does not need to route additional wiring between sensor assembly 300 and circuit board 195 after sensor assembly 300 is attached to lower end 140b of carrier 140). Rather, the arrangement and design of connectors 370, 371, and connector tab 386 may provide a predetermined alignment to the appropriate locations or contacts on circuit board 195, so that the mechanical attachment of sensor assembly 300 to lower end 140b of carrier 140 as described above also facilitates the above described electrical connections.

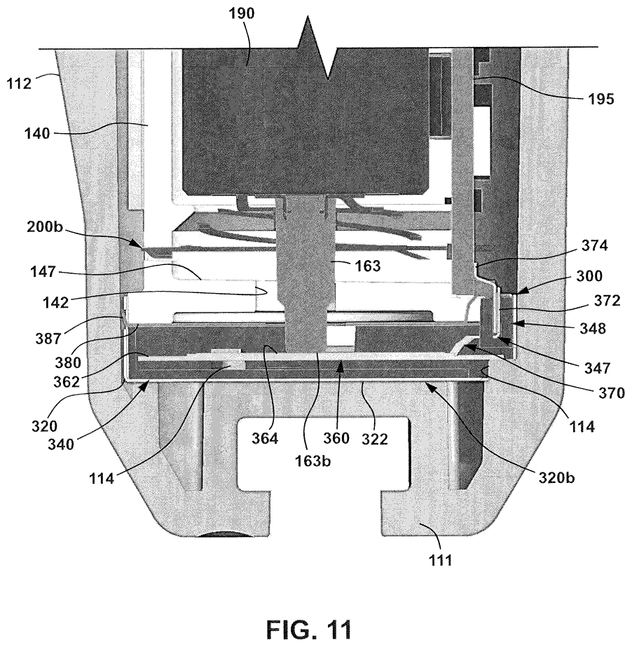

Referring to FIG. 11, when sensor assembly 300 is mounted to lower end 140b of carrier 140 as described above, post 163 is inserted through aperture 384 in cover plate 380 so that distal end 163b of post 163 engages with piezoelectric element 386 of sensor element 360. Thus, as post 163 moves axially within throughbore 142 and aperture 384, distal end 163b transfers forces and pressure to sensor element 360 so that element 360 (particularly piezoelectric element 364) begins to generate electrical signals that are indicative of the vibrations transferred to sensor 100 during operations as described in more detail below.

Referring now to FIGS. 3 and 11, after sensor assembly 300 is secured to lower end 140b of carrier 140, both are inserted within cavity 102 of housing 101 such that lower end 320b of cup 320 (particularly base plate 322) is engaged with base 111. In addition, as best shown in FIG. 11, when lower end 320b of cup 320 in sensor assembly 300 is seated against base 111, a plurality of internal projections 114 formed within body 110 of housing 101 are inserted through the aligned apertures 326, 354 and engage directly with sensor element 360 (particularly with metallic disc 362). Thus, once carrier 140 and sensor assembly 300 are installed within cavity 102 of housing 101, sensor element 360 is axially and radially suspended within recess 345 and does not directly contact holder 340. Rather, sensor element 360 is in direct contact with housing 101 via projections 114. While not specifically shown in FIG. 11, in this embodiment, there are a total of three projections 114 that are generally aligned with the aligned apertures 326, 354 of sensor assembly 300.

Referring now to FIGS. 2, 3, and 11, during seismic surveys, a plurality of sensors 100 are coupled to the surface of the earth (e.g., in place of sensors 64, 66, 68 in system 50 shown in FIG. 1). Each sensor 100 may, for example, be attached to a spike which is pushed into the earth. Alternatively, the entire sensor 100 may be buried, or placed at depth in a borehole. Regardless of how sensors 100 are coupled to the earth, each sensor 100 is preferably positioned with axis 105 oriented in a generally vertical direction (e.g., aligned with the force of gravity).

The arrival of a compressional seismic wave causes outer housing 101 and the components fixably coupled thereto (e.g., spool assembly 130, carrier 140, circuit board 195, light guide 129, etc.) to move in a generally vertical direction. The inertia of the proof mass (which in this embodiment comprises battery 190 as previously described above) within outer housing 101 causes the proof mass to resist moving with the displacement of the outer housing 101 and carrier 140, and consequently the outer housing 101 and carrier 140 reciprocate axially relative to the proof mass, as permitted by tabs 200 and biasing member 250. This movement causes tabs 200 and free portion 254 (including engagement member 260) of biasing member 250 to flex or be deflected and the load of the proof mass to be taken up by the sensor element 360, via post 163. The axial reciprocation of the outer housing 101 and carrier 140 relative to the proof mass generally continues as the compressional seismic wave passes across sensor 100.

During the axial reciprocations of the outer housing 101 and carrier 140 relative to the proof mass, the sensor element 360 is cyclically deflected by post 163. As previously described, when mechanical stress is applied to sensor element 360 due to deformation or deflection by post 163, the piezoelectric ceramic material of piezoelectric element 364 generates an electrical potential (piezoelectric effect). The electrical potential is conducted to circuit board 195 via leads 376, 374 of first connector 370 and/or leads 373, 373 of second connector 371 (see FIG. 6). The circuit board 195 (or components thereof) may sample and store the conducted electrical potential in memory as a measure of the amplitude of the seismic vibration. Thus, during operations, the sensor element 360 generates a signal that is indicative of the vertical movement of the outer housing 101 relative to the proof mass (e.g., battery 190) as induced by the seismic vibration. The data stored in memory on the circuit board 195 can be communicated to an external device for further consideration and analysis (e.g., via light guide 228, and top 221 as previously described).

During these operations, sensor element 360 is shielded from electromagnetic interference by the conductive housing 310 as previously described above. Such electromagnetic interference may be generated by other electronic components within sensor 100 (e.g., battery 190, inductive spool assembly 130, circuit board 195, etc.) or by sources disposed outside of sensor 100 (e.g., other electronic components disposed adjacent to sensor 100 during a seismic survey). Thus, by enclosing sensor element 360 within a conductive housing 310 as described above, the amount of signal noise caused by such electromagnetic interference may be reduced (or eliminated entirely). Accordingly, the quality of seismic signals collected by the seismic sensors disclosed herein (e.g., sensor 100) may be improved.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A sensor assembly for a seismic sensor, the sensor assembly comprising:
an electrically conductive outer housing;
an electrically insulating holder disposed within the outer housing, wherein the holder comprises a recess; and
a sensor element disposed within the recess of the holder, wherein the sensor element is electrically insulated from outer housing by the holder.

2. The sensor assembly of claim 1, wherein the holder comprises a receptacle; and
wherein the sensor assembly further comprises a connector comprising:
a body received within the receptacle;
a first electrically conductive lead extending outside of the outer housing; and
a second electrically conductive lead coupled to the sensor element.

3. The sensor assembly of claim 2, wherein the outer housing comprises:
a cup including a base plate and a plurality of wall segments, wherein the plurality of wall segments extend from a periphery of the base plate in an axial direction with respect to a central axis of the sensor assembly; and
a cover plate including a plurality of tabs, wherein the plurality of tabs extend from a periphery of the cover plate,
wherein the plurality of tabs and the periphery of the cover plate are engaged with the plurality of wall segments of the cup, and wherein the cup and the cover plate comprise an electrically conductive material.

4. The sensor assembly of claim 3, wherein the cover plate comprises a radially extending notch in the periphery of the cover plate, and wherein the receptacle of the holder is received through the notch of the cover plate.

5. The sensor assembly of claim 4, wherein the cover plate includes a first aperture extending into the recess of the holder.

6. The sensor assembly of claim 5,
wherein the cup includes a plurality of second apertures, and
wherein the holder comprises a plurality of third apertures that are angularly aligned with the plurality of second apertures about the central axis to expose the recess of the holder.

7. The sensor assembly of claim 1, wherein the holder comprises:
a base,
an annular wall extending axially from the base, wherein the base the annular wall form the recess, and
a retention recess extending radially into the annular wall, wherein a portion of the sensor element is received within the retention recess.

8. The sensor assembly of claim 1, wherein the sensor element comprises a piezoelectric element.

9. A seismic sensor, comprising:
an outer housing having a central axis, an upper end, a lower end, and an inner cavity;
a proof mass moveably disposed in the inner cavity, wherein the outer housing is configured to move axially relative to the proof mass;
a plurality of biasing members disposed within the inner cavity and configured to flex in response to axial movement of the outer housing relative to the proof mass; and
a sensor assembly disposed in the inner cavity and axially positioned between the proof mass and the lower end of the outer housing, wherein the sensor assembly comprises:
an electrically conductive sensor housing;
an electrically insulating holder disposed within the sensor housing, wherein the holder comprises a recess; and
a sensor element disposed within the recess of the holder, wherein the sensor comprises a piezoelectric element, and wherein the sensor element is electrically insulated from the sensor housing by the holder.

10. The seismic sensor of claim 9, further comprising a post coupled to a lower end of the proof mass, wherein the post is received through a first aperture in the sensor housing and is engaged with the piezoelectric element of the sensor element.

11. The seismic sensor of claim 10, wherein the sensor housing comprises a plurality of second apertures,
wherein the holder comprises plurality of third apertures that are aligned with the plurality of second apertures, and
wherein the sensor housing comprises a plurality of projections within the inner cavity that engage with the sensor element through the plurality of second apertures and the plurality of third apertures to suspend the sensor element within the holder.

12. The seismic sensor of claim 11, wherein the sensor housing comprises:
a cup comprising a base plate and a plurality of wall segments, wherein the plurality of wall segments extend axially from a periphery of the base plate; and
a cover plate comprising a plurality of tabs, wherein the plurality of tabs extend from a periphery of the cover plate,
wherein the plurality of tabs and the periphery of the cover plate are engaged with the plurality of wall segments of the cup, and wherein the cup and the cover plate comprise an electrically conductive material.

13. The seismic sensor of claim 12, wherein the cover plate comprises the first aperture and wherein the cup comprises the plurality of second apertures.

14. The seismic sensor of claim 13, wherein the holder comprises receptacle; and
wherein the sensor assembly further comprises a connector comprising:
a body received within the receptacle;
a first electrically conductive lead that extends from the body outside of the sensor housing to contact a circuit board within the inner cavity; and
a second electrically conductive lead that extends from the body and is coupled to the piezoelectric element of the sensor element.

15. The seismic sensor of claim 14, wherein the holder comprises:
a base,
an annular wall extending axially from the base, wherein the base the annular wall form the recess, and
a retention recess extending radially into the annular wall, wherein a portion of the sensor element is received within the retention recess.

16. The seismic sensor of claim 15, wherein the cover plate comprises a radially extending notch in the periphery of the cover plate, and wherein the receptacle of the holder is received through the notch of the cover plate.

17. The seismic sensor of claim 16, further comprising a carrier fixably coupled to the sensor housing and disposed within the inner cavity, wherein the plurality of biasing members are fixably coupled to the carrier, wherein the proof mass is movably disposed within the carrier, and wherein a lower end of the carrier is engaged with the cover plate of the sensor housing.

18. The seismic sensor of claim 17, wherein the at least one of the plurality of tabs of the cover plate is engaged within a recess in the carrier.

19. A method of manufacturing a seismic sensor, the method comprising:
(a) inserting a sensor element within a recess of an electrically insulating holder;
(b) enclosing the holder and the sensor element within an electrically conductive sensor housing after (a);
(c) engaging the sensor housing with an end of a carrier after (b);
(d) suspending a proof mass within the carrier via a plurality of biasing members; and
(f) inserting the carrier, the sensor housing, and the proof mass within an outer housing after (c) and (d) such that the sensor element is deflected when the carrier moves relative to the proof mass.

20. The method of claim 19, comprising:
(g) engaging a conductive lead with a circuit board coupled to the carrier during (c), wherein the conductive lead that is coupled to the sensing element and extends from the sensor housing.
